(19) United States
(12) Patent Application Publication
(10) Pub. No.: US 2026/0317867 A1
(43) Pub. Date: Oct. 15, 2026

(54) HEAT TREATMENT OF CAST TUNGSTEN CARBIDE PARTICLES TO IMPROVE IMPACT RESISTANCE

(71) Applicant: OERLIKON METCO (US) INC., Westbury, NY (US)

(72) Inventors: Bernard LAROUCHE, Meiningen (DE); Zhe ZHANG, Katy, TX (US); Andrew BELL, Shebbear, Devon (GB); Zhongming WANG, Houston, TX (US)

(73) Assignee: OERLIKON METCO (US) INC., Westbury, NY (US)

(21) Appl. No.: 19/479,124

(22) PCT Filed: Apr. 26, 2024
(86) PCT No.: PCT/US2024/026515

§ 371 Date: Oct. 27, 2025

Related U.S. Application Data
(60) Provisional application No. 63/462,407, filed on Apr. 27, 2023.

(51) Int. Cl. C22C 29/08; C01B 32/949; C22C 29/06

(52) U.S. Cl. CPC C22C 29/08; C01B 32/949; C22C 29/067; C01P 2002/72; C01P 2006/21

(57) ABSTRACT

A cast tungsten carbide powder, method of making the powder and feedstock including the powder include a powder including a tungsten carbide (monocarbide) phase; and a metallic tungsten phase. The cast tungsten carbide powder may include a residual amount of W₂C (hemicarbide) phase.

### CROSS-REFERENCE TO RELATED APPLICATION

This Application is an International Application claiming the benefit of priority of U.S. Provisional Application No. 63/462,407 filed Apr. 27, 2023, the disclosure of which is expressly incorporated by reference herein in its entirety.

### BACKGROUND

### 1. Field of the Invention

Embodiments are directed to the effect of heat treatment of cast tungsten carbide (CTC) powder on mechanical and tribological properties of the material.

### 2. Discussion of Background Information

Commercial cast tungsten carbide (CTC) powders are generally fabricated by melt-casting from a mixture of tungsten and carbon in graphite crucibles. The melt is cast and rapidly quenched in water-cooled copper molds to form a very hard carbide with fine microstructure. This material is afterwards crushed down into finer particles, with angular shapes, and sieved to obtain a desired particle size range. These angular CTC particles can also be melted in a hot plasma or a graphite furnace to produce spherical particles of the same material. The carbon content is generally between 3.7 and 4.1 wt. % C (37.0 and 39.6 at. % C), which approximately corresponds to the carbon content of the cubic WC_{1-X} phase that forms at the start of the solidification of the liquid at ≈2735° C. (see the W—C phase diagram (FIG. 1)).

This cubic phase rapidly decomposes by eutectoid reaction (2530° C.) into hemicarbide W₂C and monocarbide WC, thus producing a very fine feather-like microstructure of both phases. According to the W—C phase diagram of FIG. 1, the W₂C phase is only stable above 1250° C. and should transform by eutectoid reaction into WC and metallic tungsten.

However, due of the fast-cooling rate of the manufacturing process, the W₂C phase formed at high temperature is kept after cooling at room temperature. Therefore, the typical final eutectoid microstructure of CTC after cooling consists of fine alternated platelets of metastable W₂C and WC (which is stable at room temperature). The proportion of each phase in the powders is around 75% W₂C and 25% WC.

CTC powders are used with a metallic binder (matrix) to form hardfacing on steel parts using a welding/cladding or brazing processes. The powders are mainly used in applications requiring good wear and impact resistance such as drill bits and stabilizers for oil industry, ground engaging tools, crushing hammer and roller in mining, rock cutting and tunnel boring, and other applications subjected to severe wear.

One of the drawbacks of CTC powders arises from the very high hardness (>2300 HV) which results in a brittle material. Indeed, W₂C, the main phase of the carbide, is known to be harder but more brittle than the WC phase. This characteristic results in a lower fracture toughness of the carbide powders and a decrease in the CTC powder performance in applications subject to impact wear.

### SUMMARY

Embodiments are directed to CTC powders in which the brittle W₂C phase is transformed into WC phase and more ductile metallic tungsten by heat treatment. In this way, CTC powders with better toughness can be obtained and therefore coatings (hardfacing) containing these carbides with both improved abrasion and impact resistance can be achieved.

According to embodiments, heat treatment of CTC powder can have many beneficial effects on the mechanical and tribological properties of the material. First, it refines the microstructure of the carbide by transforming the W₂C phase (hemicarbide) into very fine WC (monocarbide) and metallic tungsten phase. In particular, a very fine eutectoid microstructure (small crystal size) composed of alternated WC and W platelets is thus created by the eutectoid reaction of the metastable hemicarbide phase below 1250° C.

Another beneficial effect of the heat treatment of CTC powders is to eliminate the free carbon (graphite) that is often present in standard CTC, since graphite is a soft and brittle compound that impairs the carbide properties in terms of hardness, toughness, and wear resistance.

Embodiments are directed to a cast tungsten carbide powder that includes a tungsten carbide (monocarbide) phase; a metallic tungsten phase and may include a residual amount of hemicarbide (W₂C) phase.

In embodiments, the geometry of the CTC powders can be either substantial angular or substantial spherical. The substantial angular carbides can have a ratio of a first length along a major axis to second length along a minor axis that is higher than 1.2. The substantial spherical carbides have a ratio of a first length along a major axis to second length along a minor axis that is 1.2 or lower.

In embodiments, the cast tungsten carbide powder has a carbon content of 3.0-4.5 wt. %.

In embodiments, the CTC powder includes a metallic tungsten phase with a fraction of 1 wt. %-50 wt. %, preferably 5 wt. %-50 wt. %, and most preferably 10 wt. %-50 wt. %.

In embodiments, the CTC powders have a thermal conductivity of 1.1-3.5 times higher than the standard CTC carbides consisting of the monocarbide (WC) and hemicarbide (W₂C) phases without heat treatment, preferably 1.1-3.0 higher, and most preferably 1.1-2.5 time higher. While the thermal conductivity of the powders without heat treatment may vary depending on factors such as the lot and morphology of the carbides. This is a calculated property according to the thermal conductivity of each phase from textbooks and the phase fractions obtained from XRD patterns. Based on the data that we have, the thermal conductivity of the CTC powders without heat treatment is between 50.0-91.0 W/(mK).

In embodiments, the CTC powders have a thermal shock resistance of 1.1-8.0 times higher than that of standard CTC powders consisting of the monocarbide (WC) and hemicarbide (W₂C) phases without heat treatment, preferably 1.2-7.0 times higher, and most preferably 1.6-6.5 times higher.

Embodiments are directed to a feedstock that includes the cast tungsten carbide powder, as discussed above, and a metal alloy.

In accordance with embodiments, the cast tungsten carbide powder can have a unimodal size distribution of one of: 45-325 mesh; 45-60 mesh; 60-100 mesh; 70-200 mesh; 100-200 mesh; 100-325 mesh; 200-450 mesh or 200-325 mesh.

In accordance with other embodiments, the cast tungsten carbide powder can have a bimodal size distribution of non-overlapping ranges that is one of: 45-60 mesh carbide particles and 200-325 mesh carbide particles; 45-60 mesh carbide particles and 100-325 mesh carbide particles; 45-60 mesh carbide particles and 100-200 mesh carbide particles; 45-60 mesh carbide particles and 200-450 mesh carbide particles; or 60-100 mesh carbide particles and 100-325 mesh particles. A coarser of the carbide particles in the bimodal size distribution may include 30-80 wt. % of a total carbide component of the feedstock.

According to embodiments, the metal alloy may include nickel, cobalt, copper or iron alloy.

In other embodiments, a total weight fraction can include 5-95 wt. % carbide, preferably 50-90 wt. % carbide and most preferably 60-80 wt. % carbide.

Embodiments are directed to a method of forming a cast tungsten carbide powder that includes casting and quenching a mixture of tungsten and carbon in a mold to form a material comprising a cubic WC_{1-X} phase, a W₂C (hemicarbide) phase; and a WC (monocarbide) phase that can either be atomized into spherical particles while in molten state or cooled down then mechanically crushed into angular particles. The angular particles may optionally undergo further spheroidization by plasma. The method further includes sieving the carbide particles, i.e., spherical and/or angular, into a powder within a predetermined particle size range; and heat treating the powder to transform the W₂C (hemicarbide) phase into WC (monocarbide) and W (metallic tungsten) phases in a heat-treated powder.

For example, the heat treating transforms the W₂C (hemicarbide) phase in the powder into about 52 wt. % WC (monocarbide) phase and about 48 wt. % W metallic tungsten phase in the heat-treated powder. The heat-treated powder can have a final composition of about 64 wt. % WC and about 36 wt. % W. Further, the pre-heat treated powder can also include graphite that is eliminated in the heat-treated powder.

According to embodiments, the heat treatment may include, in a non-oxidizing atmosphere, exposing the powder to a temperature of at least 1000° C. and less than 1250° C. for 0.5-50 hrs.

Embodiments are directed to a cast tungsten carbide powder formed according to the method described above.

Embodiments are directed to a feedstock that includes the cast tungsten carbide powder described above; and a metallic alloy component. The feedstock may include one of a powder feedstock, a cored wire feedstock, a rod feedstock, or flexible rod feedstock.

According to embodiments, when the feedstock includes one of the cored wire feedstock, the rod feedstock, and the flexible rod feedstock, the metallic alloy component can be present as one of a sheath of the cored wire feedstock, the rod core of the rod core or flexible rod feedstock, or metal powder.

In accordance with still yet other embodiments, the metallic alloy component may include one of a nickel alloy, a copper alloy, a cobalt alloy or an iron alloy. The nickel alloy can be a self-fluxing alloy comprising a NiCrSiB alloy or a NiSiB alloy.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a Carbon-Tungsten Phase Diagram;

FIG. 2 shows a comparison of XRD diffraction patterns of angular CTCs before and after the heat treatment under 1225° C. and 20-hour soak time;

FIG. 3 shows a heat treatment sequence for the CTC powders;

FIG. 4 shows a comparison of Palmqvist Toughness Test results for standard CTC powders and heat-treated CTC powders;

FIG. 5 graphically illustrates comparative microhardnesses of CTC, heat-treated CTC and MTC (100% WC) powders;

FIG. 6 shows a microstructure comparison of laser cladding of heat-treated CTC powders vs. laser cladding of standard CTC powders (in METCO 7010, a NiSiB matrix); and

FIG. 7 shows a comparison of results for rotary impact wear testing between laser cladding coatings containing standard CTC powders and heat-treated CTC powders (with 35 wt. % METCO 7010).

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In embodiments, cast tungsten carbide (CTC) powders are treated to transform the brittle W₂C phase into WC phase and more ductile metallic tungsten. This heat treatment produces or obtains CTC powders with better toughness than standard or non-heat treated CTC powders, such that coatings (e.g., hardfacing) containing these carbides of the heat treated CTC powders achieve both improved abrasion and impact resistance. While total elimination of the hemicarbide is desired, this desired phase transformation and complete decomposition of the hemicarbide phase requires a long soak time. The inventors have found that by adopting short soak times of 20 hours or less, the heat treated CTC includes a metallic tungsten phase with the a fraction of 1 wt. %-50 wt. %, preferably 5 wt. %-50 wt. %, and most preferably 10 wt. %-50 wt. %. with only a residual amount of hemicarbide, which provides the benefits sought in the embodiments.

As described herein, the shape of the CTC powders can be defined by an aspect ratio of a first length along a major axis to a second length along a minor axis, or a ratio of the longest axis length to the shortest axis length. The spherical or substantially spherical particles have an aspect ratio of 1.20 or lower. The angular or substantially angular particles have an aspect ratio of higher than 1.2. In embodiments, both the substantially spherical particles and substantially angular CTC powders can be processed through heat treatment process.

Heat treatment of CTC powder can refine the microstructure of the carbide by transforming the W₂C phase (hemicarbide) into very fine WC (monocarbide) and metallic tungsten phase. The final microstructure of the carbide after heat treatment consists of WC, W₂C, and tungsten phase. The fraction of tungsten phase within the CTC powder after the heat treatment ranges from 1 wt. % to 50 wt. %. In one embodiment, the tungsten phase is in between 1 wt. %-50 wt. %. In still another embodiment, the tungsten phase is in between 5 wt. %-50 wt. %. In still another embodiment, the tungsten phase is in between 10 wt. %-50 wt. %.

For example, FIG. 2 shows the XRD pattern of the angular CTC powders before and after the heat treatment. The treatment was conducted under the temperature of 1225° C. and 20 hr. soak time. Before the treatment, the CTC powders consist of W₂C, WC, and graphite phases. After the treatment, the CTC powders consist of tungsten (W) and WC phases. According to the XRD diffraction pattern and the Rietveld method, the heat-treated CTC powders consist of 59.1% WC, 40.1% tungsten, and 0.8% W₂C phases.

Another beneficial effect of the heat treatment of CTC powders is to eliminate the free carbon (graphite) that is often present in standard CTC, since graphite is a soft and brittle compound that impairs the carbide properties in terms of hardness, toughness and wear resistance. Phase analysis by x-ray diffraction (XRD) of a CTC powder initially containing graphite phase is carried out and shows that graphite entirely reacted with tungsten and formed tungsten carbide phase after heat treatment (see FIG. 2).

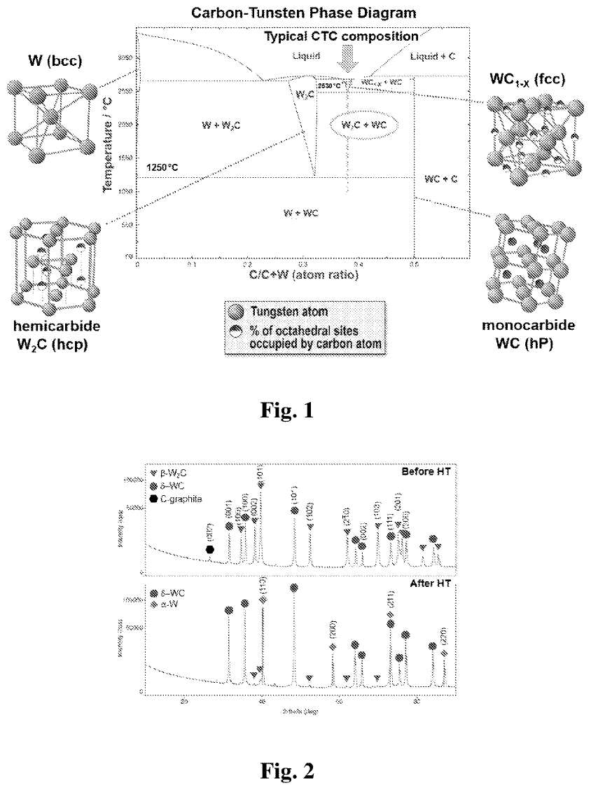

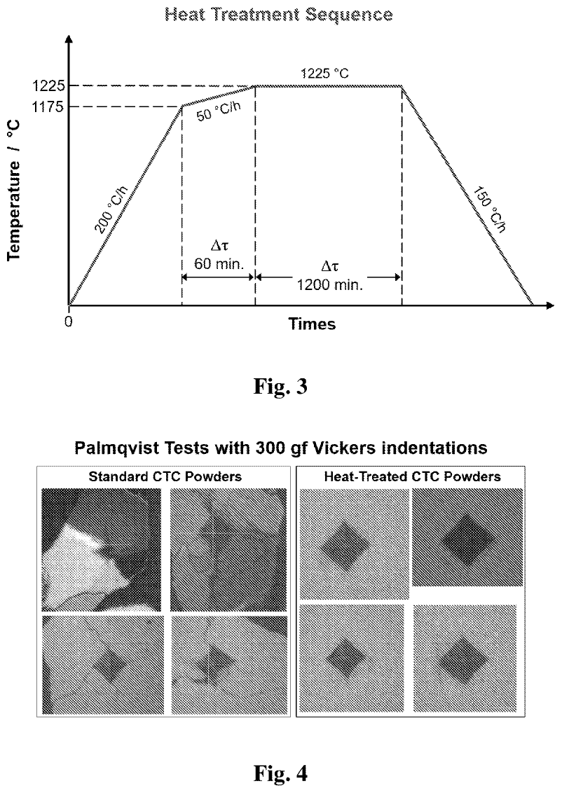

In order to transform the hemicarbide phase presented in standard CTC powders, these powders must be subjected to a heat treatment under non-oxidizing atmosphere. The duration and temperature of the heat treatment must be long and high enough to allow the carbon diffusion kinetics in W₂C to be sufficiently high and promote the phase transformation of the metastable hemicarbide into monocarbide and metallic tungsten. Based on the C—W phase equilibrium diagram of FIG. 1 and different tests, the temperature range for heat treatment should be above 1000° C., and below 1250° C., i.e., the eutectoid temperature of the hemicarbide. It was found that heat treatments at temperatures below 1000° C. did not result in transformation of the hemicarbide phase. An exemplary heat treatment sequence is shown in FIG. 3.

Duration of the heat treatment at maximum/heat treatment temperature should be between 0.5-50 hrs. to enable the transformation of the hemicarbide phase. The atmosphere in the furnace should contain non-oxidizing gas (e.g., argon or hydrogen) with a very low fraction of oxygen to prevent any oxidation (e.g., formation of WO₃ oxide layer over ≈500° C.) at the surface of the CTC powder during the heat treatment.

As discussed above, heat treatment of CTC powders transforms the harder and more brittle hemicarbide phase into a very fine eutectoid microstructure consisting of monocarbide and ductile metallic tungsten phase. This phase transformation contributes to improving the toughness and impact resistance of the heat-treated CTC powders as compared to the standard CTC material. This behavior was confirmed by the results of different tests and analysis to assess the toughness of CTC powders after a heat treatment at 1225° C. for 20 hours in a vacuum furnace. FIG. 4 shows comparative results of Palmqvist toughness tests with 300 gf Vickers indentations using a square base diamond pyramid intender on standard CTC powders vs. heat-treated CTC powders, where the heat-treated CTC powders exhibit a much lower tendency to crack at the corners of the indentation than the standard CTC powders.

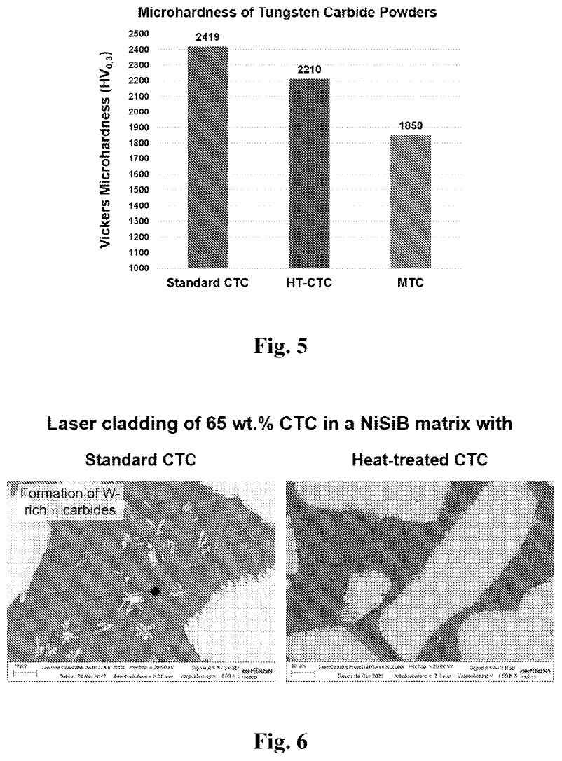

As shown in FIG. 5, the hardness of heat-treated CTC powders is lower than that of standard CTC by around 200 HV_{0.3}. However, as compared to monocrystalline tungsten carbide (MTC), which contains 100% monocarbide phase (WC), heat-treated CTC powders have a significantly higher hardness, even if they contain only between 60 and 70% of monocarbide and 30 to 40% of softer metallic tungsten phase. In this case, the very fine eutectoid microstructure obtained by the heat treatment is clearly a contributing factor to this hardness increase.

In the same way as standard CTC powders, heat-treated CTC powders can be mixed with Ni-, Cu-, Co- or Fe-based metal matrices to form wear-resistant metal matrix composite (MMC) coatings. A wide variety of hardfacing processes can be used to produce these coatings such as laser cladding, plasma transferred arc (PTA) cladding, MIG and TIG welding, oxyfuel brazing and other hardfacing processes.

When MMC coatings containing standard CTC powders are clad with high heat input welding processes on parts, a major drawback has been the thermally induced dissolution of the carbide particles in the molten bath. Indeed, the metastable hemicarbide phase composing a high fraction of the standard CTC particles is known to be more prone to dissolve in liquid metal compared to the monocarbide phase. Dissolution of carbide phases in the liquid metal has a detrimental effect on the wear performance of MMC coatings since it reduces the volume fraction of primary carbide in the coating. Moreover, during molten pool solidification, dissolved W and C in the liquid metal matrix tends to form complex η carbides—precipitation of brittle (W,M)₆C- and (W,M)₁₂C-type carbides (M=Ni, Co, Fe, Cr . . . )—by reaction with elements present in the liquid metal. The precipitation of these complex carbides usually increases the hardness but also the brittleness of the metallic matrix.

Thus, a beneficial effect of the heat treatment of CTC powders is that, since there is no or less metastable hemicarbide phase present in the carbide than non-heat-treated powder, the formation of these brittle n carbides in the metal matrix after cladding is significantly reduced. This contributes to keep a better ductility and toughness to the metal matrix.

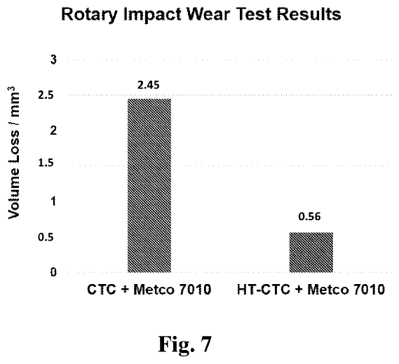

As a result of the better carbide fracture toughness as well as the better ductility of the metal matrix (due to lower formation of brittle n carbides), MMC coatings containing heat-treated CTC powders have a better impact wear resistance as compared to the same coating containing standard CTC. Results of rotary impact wear tests in FIG. 7, which were carried out on laser cladding coatings containing 65 wt. % standard and heat-treated CTC powders (−150+53 μm) in a Ni-based matrix, show a decrease in the impact wear volume loss of more than 77% with the heat-treated CTC powders.

Another beneficial effect of MMC coatings containing heat-treated carbides is the better high-stress abrasion resistance of the coatings. Owing to their better toughness, heat-treated CTC carbides are less prone to crack when they are subjected to high stress contact. According to the ASTM B611 standard (high-stress slurry abrasion test using a steel wheel), coatings containing heat-treated CTC powders in a Ni-based matrix and brazed on a steel part by oxyfuel welding have a better high-stress abrasion resistance (54% less volume loss) than coatings with the same amount of standard CTC powders.

In still another benefit of the effect of the heat treatment of CTC powders is the improvement on the thermal conductivity. The thermal conductivity of W, WC, and W₂C phases is listed in table 1. As the table illustrated, the W phase has a much higher thermal conductivity than the W₂C phase. The heat treatment of the CTC powders results in the decomposition of W₂C with low thermal conductivity to W and WC phases with high thermal conductivity. Therefore, the thermal conductivity of the CTC powders is improved after the heat treatment. The thermal conductivity of the CTC powders before and after heat treatment can be calculated based on the mixture laws, thermal conductivity of each phase, and the phase fractions obtained from the XRD patterns.

In some embodiments, the thermal conductivity of the heat-treated CTC powders is 1.1-3.5 times higher than that of standard CTC powders without heat treatment. In preferred embodiments, the thermal conductivity of the heat-treated CTC powders is 1.1-3.0 times higher than that of regular CTC powders without heat treatment. In more preferred embodiments, the thermal conductivity of the heat-treated CTC powders is 1.1-2.5 times higher than that of regular CTC powders without heat treatment. While it is understood that the thermal conductivity of CTC powders without heat treatment may vary depending on factors such as the lot and morphology of the carbides, heat conductivity of such CTC powders, which can be a calculated property according to the thermal conductivity of each phase from textbooks and the phase fractions obtained from XRD patterns, is between 50.0-91.0 W/mK.

In still another benefit of the effect of the heat treatment of CTC powders is the improvement on the thermal shock resistance. According to the U.S. Pat. No. 10,760,343B2, the thermal shock resistance (TSR) can be estimated by using the equation below. Table 1 shows the details of the thermo-mechanical properties of different W related phases. All the data were obtained from the literatures. By considering the average value of the properties, the TSR of each could be calculated. As seen from the table, W phase has the highest TSR. The TSR of WC and W₂C phases are only 13% and 7%, respectively, of that of W. After the heat treatment, the W is formed while the W₂C is decomposed, resulting in an improvement on the TSR of the CTC powders. The TSR of the CTC powders before and after heat treatment can be calculated based on the mixture laws, phase fractions obtained from the XRD patterns, and the TSR of each W related phases. In some embodiments, the TSR of the heat-treated CTC powders is 1.1-8.0 times higher than that of standard CTC powders without heat treatment, where the thermal shock resistance of CTC powders without heat treatment is between 7.99 and 10.64 kWm. In some preferred embodiments, the TSR of the heat-treated CTC powders is 1.2-7.0 times higher than that of regular CTC powders without heat treatment. In some more preferred embodiments, the TSR of the heat-treated CTC powders is 1.6-6.5 times higher than that of regular CTC powders without heat treatment.

$$T ≅ \frac{σ k ( T )}{E ( T ) α ( T )}$$

where σ is the mean transverse rupture strength, k is the thermal conductivity, E is the Young's modulus, and a is the thermal expansion coefficient.

TABLE 1
Thermo-mechanical properties of different phases

| | Tensile | | | Coefficient of | |
|---|---|---|---|---|---|
| | strength | Thermal | Young's | Thermal | |
| | (MPa)- | conductivity(W | Modulus | Expansion(1/ | Relative TSR |
| Phase | σ | m⁻¹K⁻¹) − k [1] | (GPa)-E | K × 10⁻⁶) | to W phase, % |
| W | 867- | 174 | 399-411 | 4.5-4.6 | 100% |
| | 1187[5] | | | | |
| WC | 296- | 120 | 615-707 | 5.5 [2] | 13% |
| | 490 [6] | | | | |
| W₂C | 462 [7] | 36 | 444 [4] | 5.3-6.2[3] | 7% |

[1] Huang, S., Guo, H., Zhang, Z., Zhang, X., Xie, H., Xie, Z., Peng, L. and Mi, X., 2020. Comparative study on the properties and microscopic mechanism of Ti coating and W coating diamond-copper composites. Materials Research Express, 7(7), p. 076517.
[2] Tungsten carbide-Wikipedia
[3] Zhang, D., Li, Z., Shan, Q., Jiang, Y., Feng, J. and Chong, X., 2020. Thermodynamic analysis of the interface reaction and thermal stress of WCp/Fe composites. Ceramics International, 46(16), pp. 26210-26215.
[4] Taimatsu, H., Sugiyama, S. and Kodaira, Y., 2008. Synthesis of W2C by reactive hot pressing and its mechanical properties. Materials transactions, 49(6), pp. 1256-1261.
[5] Krsjak, V., S. H. Wei, S. Antusch, and Y. Dai. “Mechanical properties of tungsten in the transition temperature range.” Journal of Nuclear Materials 450, no. 1-3 (2014): 81-87.
[6] Cardarelli, Francois. “Materials handbook: a concise desktop reference.” (2008).
[7] García-Ayala, E. “Aqueous colloidal processing of W and WC-based composites, sintering and mechanical properties at high temperature.” (2021).

For all these reasons, heat-treated CTC powders are well suited to applications that require excellent abrasion and impact wear resistance as well as applications subject to high stress contact at the part surface. The applicable industries and related parts are included but not limited to PDC drill bits, stabilizers, Rotary bi- and tri-cone drill bits in oil gas industry; rock crushing hammer & rolls, scraper blades, crusher jaws, teeth & blades, chute liner, impact crusher, crusher roll shell, and classification screens in mining industry; plowshare, and tiller blades in agriculture industry; debarking knives, and mulcher knives in forestry industry. Other parts suitable for the application of the heat-treated carbides include but are not limited to ground engaging tools (GET), slurry pump impellers & casing, shearing blades, guiding rolls, sugarcane mill rollers, and conveyor screws.

### Examples

In some embodiments, the heat-treated carbide can be blended with a metal alloy (e.g., Ni-based alloys, such as NiCrSiB and NiSiB self-fluxing alloys, as well as Cu-, Co- or Fe-based alloys) for use as a feedstock in welding processes. In some embodiments, a feedstock comprising heat-treated carbides can be a powder for use in laser cladding, high speed laser cladding (EHLA), plasma transferred arc (PTA) welding, oxyfuel/spray and fuse cladding. In some embodiments, a feedstock comprising heat-treated carbides is a cored wire for MIG, TIG, SMAW, MMAW, or FCAW welding. In some embodiments, a feedstock comprising heat-treated carbides can be a rod or flexible cord for oxyfuel welding/brazing.

In some embodiments the feedstock is unimodal in size distribution. In some embodiments the feedstock can include 45-325 mesh carbide particles. In some embodiments the feedstock can include 45-60 mesh carbide particles. In some embodiments the feedstock can include 60-100 mesh carbide particles. In some embodiments the feedstock can include 70-200 mesh carbide particles. In some embodiments, the feedstock can include 200-325 mesh carbide particles. In some embodiments, the feedstock can include 200-450 mesh carbide particles. In some embodiments, the feedstock can include 100-200 mesh carbide. In some embodiments, the feedstock can include 100-325 mesh carbide.

In some embodiments the feedstock may be bimodal in distribution and thus contain two particle size modes of non-overlapping size ranges. In an embodiment, the feedstock can include 45-60 mesh carbide particles and 200-325 mesh carbide particles. In another embodiment, the feedstock can include 45-60 mesh carbide particles and 200-450 mesh carbide particles. In another embodiment, the feedstock can include 45-60 mesh carbide particles and 100-325 mesh carbide particles. In still another embodiment, the feedstock can include 45-60 mesh carbide particles and 100-200 mesh carbide particles. In still another embodiment, the feedstock can include 40-80 mesh carbide particles and 100-325 mesh carbide particles. In still another embodiment, the feedstock can include 60-100 mesh carbide particles and 100-325 mesh carbide particles.

In some embodiments the heat-treated carbides may be combined with a metallic alloy component, e.g., a nickel alloy (such as NiCrSiB or NiSiB), a cobalt alloy, a copper alloy or an iron alloy, to form the final feedstock form. In powder feedstock embodiments, the metal component can be a powder itself. In cored wire, rod, and flexible rod feedstock embodiments, the metal component can include the sheath of the cored wire, the rod core itself, and metal powder. In some embodiments, the metal component can be a nickel alloy. In some embodiments, the nickel alloy can be a self-fluxing material. In some embodiments, the nickel alloy may be a NiCrSiB alloy. In some embodiments, the nickel alloy can be a NiSiB alloy. In some embodiments, the metal component can be a cobalt, copper or iron alloy. An exemplary nickel-based alloy includes but is not limited to nickel balanced with 1%-5% boron by weight, 1%-5% silicon by weight, and optionally, up to 12% chromium by weight and/or up to 5% iron by weight. An exemplary cobalt-based alloy includes but is not limited to cobalt balanced with 25%-30% chromium by weight, and optionally, up to 10% tungsten by weight, up to 5% nickel by weight, up to 3% iron by weight, up to 2% silicon by weight, and/or up to 2% carbon by weight (STELLITE 6, 12, and 21). An exemplary iron-based alloy includes but is not limited to iron balanced with, optionally, up to 20% chromium by weight, up to 15% by weight nickel, up to 2% manganese by weight, up to 3% molybdenum by weight, up to 1% silicon by weight, and/or up to 0.2% carbon by weight.

In embodiments, the carbide can include 5-95% of the total weight fraction of the final feedstock form, preferably the carbide can include 50-90% of the total weight fraction of the final feedstock form, and most preferably the carbide can include 60-80% of the total weight fraction of the final feedstock form.

In embodiments, the shape of the carbides can be, substantial angular, substantial spherical or a combination of the two. The substantial angular carbides have a ratio of a first length along a major axis to second length along a minor axis that is above 1.2. The substantial spherical carbides have a ratio of a first length along a major axis to second length along a minor axis that is 1.2 or lower.

In some embodiments using bimodal distributions, the weight fraction of the large carbide is 30-80 wt. % of a total carbide component of the feedstock. For example, a feedstock may be comprised of 70 wt. % carbide powder and 30 wt. % NiSiB or NiCrSiB or powder. The carbide component of this example feedstock may be further broken down into 66 wt. % 45-60 mesh heat-treated carbide powder and 34 wt. % 200-325 mesh heat-treated carbide powder. In another example, the carbide component in the feedstock contains 57 wt. % 45-60 mesh heat-treated carbide and 43 wt. % 100-325 mesh heat-treated carbide. In still another example, the carbide component in the feedstock contains 78 wt. % 60-100 mesh heat-treated carbide and 22 wt. % 100-325 mesh heat-treated carbide. In another example, a feedstock may be comprised of 60 wt. % carbide powder and 40 wt. % NiCrSiB powder. The carbide component of this example feedstock contains 75 wt. % 45-60 mesh heat-treated carbide and 25 wt. % 100-200 mesh heat-treated carbide. In still another example, a feedstock may be comprised of 65 wt. % carbide powder and 35 wt. % NiCrSiB powder. The carbide component of this example feedstock contains 54% wt. % 45-60 mesh heat-treated carbide and 46 wt. % 200-450 mesh heat-treated carbide. In another example, the carbide component includes 61.5 wt. % 45-60 mesh heat-treated carbide and 38.5 wt. % 200-450 mesh heat-treated carbide.

In embodiments, a fraction of the carbides in the feedstock can be heat treated with the remaining fraction remaining in the non-heat treated, i.e., standard state. In some embodiments, 10-100 wt. % of the total carbide fraction can be heat treated carbides, preferably 20-90 wt. % of the total 1 carbide fraction may be heat treated carbides, and most preferably 30-80 wt. % of the total carbide fraction are heat-treated carbides.

In embodiments, wear resistant layers deposited by using the feedstock demonstrated above exhibit excellent high stress abrasion resistance per ASTM B611 standard. In some embodiments, the wear resistant layers containing heat-treated carbides show a volume loss of 100-400 mm³ per ASTM B611 standard. In some preferred embodiments, the wear resistant layers containing heat-treated carbides show a volume loss of 100-300 mm³ per ASTM B611 standard. In more preferred embodiments, the wear resistant layers containing heat-treated carbides show a volume loss of 120-250 mm³.

In embodiments, the wear resistant layers produced with the feedstock demonstrated above provide excellent electrical conductivity. In some embodiments, the electrical conductivity of the wear resistant layer containing heat-treated carbides is between 1.200 to 2.100 mS/m. In some preferred embodiments, the electrical conductivity of the wear resistant layer containing heat-treated carbides is between 1.300-2.100 mS/m. In more preferred embodiments, the electrical conductivity of the wear resistant layer containing heat-treated carbides is between 1.400-2.100 mS/m.

In embodiments, wear resistant layers produced with the feedstock demonstrated above have higher thermal conductivities than those of wear resistant layers with tungsten carbides without heat treatment. In some embodiments, the thermal conductivity of the wear resistant layer containing heat-treated carbides is 1.20-21.00 W/(mK). In some preferred embodiments, the thermal conductivity of the wear resistant layer containing heat-treated carbides is between 15.00-21.00 W/(mK). In more preferred embodiments, the thermal conductivity of the wear resistant layer containing heat-treated carbides is between 18.00-21.00 W/(mK).

In embodiments, wear resistant layers produced with the feedstock demonstrate above has higher thermal shock resistance than those of wear resistant layers with tungsten carbides without heat treatment.

A few examples of wear resistant layers with and without heat-treated tungsten carbides along with their related coating properties are listed in Table 2. As shown in Table 2, all of the samples have a bi-modal carbide distribution with a total carbide fraction of 60 wt. %. All the carbides inside the sample A were non-heat treated, resulting in the worst wear performance per ASTM B611 test, as well as the lowest thermal and electrical conductivity. In sample B, the large carbides with 20% weight fraction were heat treated, while the remaining carbides inside the sample are standard spherical cast tungsten carbide without heat treatment. The sample B exhibits a dramatical improvement in the wear performance per ASTM B611 standard compared to sample A. Additionally, the electrical and thermal conductivity of sample B are also improved compared to those of sample A. Sample C has a greater proportion of large carbides compared to samples A and B, with all carbides in sample C being heat treated. The wear performance per ASTM B611 standard, electrical conductivity, and thermal conductivity of sample C are further improved when compared to samples A and B.

TABLE 2
Selected wear resistant hardfacings and their related properties

| | Compositions | | | | ASTM | Electrical | Thermal |
|---|---|---|---|---|---|---|---|
| | Spherical cast | | Materials | Welding | B611, | conductivity, | conductivity, |
| Sample | tungsten carbides | Matrix | form | method | mm3 | mS/m | W/(mK) |
| A | 20 wt. % 45 × 60Mesh | 40 wt. % | Powder | Spray fuse | 414 | 1.217 | 12.07 |
| | nonheat-treated + 40 wt. % | Ni—Cr—B—Si | | | | | |
| | 100 × 200Mesh nonheat- | | | | | | |
| | treated | | | | | | |
| B | 20 wt. % 45 × 60Mesh heat- | 40 wt. % | Powder | Spray fuse | 189 | 1.513 | 15.50 |
| | treated + 40 wt. % | Ni—Cr—B—Si | | | | | |
| | 100 × 200Mesh nonheat- | | | | | | |
| | treated | | | | | | |
| C | 45 wt. % 45 × 60Mesh heat- | 40 wt. % | Composite | Oxy- | 137 | 1.963 | 20.01 |
| | treated + 15 wt. % | Ni—Cr—B—Si | rod | acetylene | | | |
| | 100 × 200Mesh heat- | | | torch | | | |
| | treated | | | welding | | | |

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A cast tungsten carbide powder comprising:
a tungsten carbide (monocarbide) phase; a metallic tungsten phase; and residual amount of a hemicarbide (W₂C) phase.

2. The cast tungsten carbide powder according to claim 1, wherein the carbon content is between 3.0 and 4.5 wt. %.

3. The cast tungsten carbide powder according to claim 1, wherein a shape of the cast tungsten carbide powder is at least one of substantially angular with a ratio of a first length along a major axis to second length along a minor axis that is above 1.2 or substantially spherical with a ratio of a first length along a major axis to second length along a minor axis that is 1.2 or lower.

4. The cast tungsten carbide powder according to claim 1, wherein the powder comprises 1% to 50% of tungsten phase.

5. The cast tungsten carbide powder according to claim 1, wherein the powder has a thermal conductivity of 1.1-3.5 times, preferably 1.1-3.0 times, and most preferably 1.1-2.5 times higher than a standard CTC carbide without heat treatment consisting of monocarbide (WC) and hemicarbide (W₂C) phases.

6. The cast tungsten carbide powder according to claim 1, wherein the powder has a thermal shock resistance of 1.1-8.0 times, preferably 1.2-7.0 times, and most preferably 1.6-6.5 times higher than a standard CTC carbide without heat treatment consisting of monocarbide (WC) and hemicarbide (W₂C) phases.

7. (canceled)

8. A feedstock comprising:
the cast tungsten carbide powder according to claim 1;
a metallic alloy component; and
a standard cast tungsten carbide powder with WC and W₂C phases.

9. The feedstock according to claim 8, wherein a fraction of the carbides from the cast tungsten carbide powder is 10-100 wt. % of a total carbide fraction, preferably 20-90 wt. % of the total carbide fraction, and most preferably 30-80 wt. % of the total carbide fraction.

10. The feedstock according to claim 8, wherein the cast tungsten carbide powder has a unimodal size distribution of one of: 45-325 mesh; 45-60 mesh; 60-100 mesh; 70-200 mesh; 100-200 mesh; 100-325 mesh; 200-325 mesh; or 200-450 mesh.

11. The feedstock according to claim 8, wherein the cast tungsten carbide powder has a bimodal size distribution of non-overlapping ranges that is one of: 45-60 mesh carbide particles and 200-325 mesh carbide particles; 45-60 mesh carbide particles and 200-450 mesh carbide particles; 45-60 mesh carbide particles and 100-325 mesh carbide particles; 45-60 mesh carbide particles and 100-200 mesh carbide particles; 40-80 mesh carbide particles and 100-325 mesh carbide particles; or 60-100 mesh carbide particles and 100-325 mesh particles.

12-21. (canceled)

22. The cast tungsten carbide powder according to claim 1, wherein a thermal conductivity of the heat-treated powder is 1.1-3.5 times, preferably 1.1-3.0 times, and most preferably 1.1-2.5 times higher than that of CTC powders without heat treatment.

23. The cast tungsten carbide powder according to claim 1, wherein the thermal shock resistance of the heat-treated powder is 1.1-8.0 times, preferably 1.2-7.0 times, and most preferably 1.6-6.5 times higher than that of CTC powders without heat treatment.

24.-25. (canceled)

26. A feedstock comprising:
the cast tungsten carbide powder according to claim 1; and
a metallic alloy component,
wherein the feedstock is formed as one of a powder feedstock, a cord wire feedstock, a rod feedstock, or flexible rod feedstock.

27. The feedstock according to claim 26, wherein, when the feedstock comprises one of the cored wire feedstock, the rod feedstock, or the flexible rod feedstock, the metallic alloy component is present as one of a sheath of the cored wire feedstock, the rod core of the rod core or flexible rod feedstock, or metal powder.

28. The feedstock according to claim 27, wherein the metallic alloy component comprises one of a nickel alloy, a copper alloy, a cobalt alloy or an iron alloy.

29.-35. (canceled)
